(19) United States
(12) Patent Application Publication
(10) Pub. No.: US 2026/0340163 A1
(43) Pub. Date: Oct. 29, 2026

(54) FRACTIONAL ACCESS CONTROL BY SELF-ADMINISTERING DOCUMENTS

(71) Applicant: FACTIFY TECHNOLOGIES INC., Dover, DE (US)

(72) Inventors: Matan Gavish, Givat Ada (IL); Gil Asher, Binyamina (IL)

(21) Appl. No.: 19/637,183

(22) Filed: Apr. 2, 2026

Related U.S. Application Data
(63) Continuation of application No. PCT/US2025/033602, filed on Jun. 13, 2025.
(60) Provisional application No. 63/661,534, filed on Jun. 18, 2024.
(60) Provisional application No. 63/668,068, filed on Jul. 5, 2024.
(60) Provisional application No. 63/674,793, filed on Jul. 23, 2024.
(60) Provisional application No. 63/680,061, filed on Aug. 6, 2024.
(60) Provisional application No. 63/685,234, filed on Aug. 20, 2024.
(60) Provisional application No. 63/693,173, filed on Sep. 10, 2024.
(60) Provisional application No. 63/707,992, filed on Oct. 16, 2024.
(60) Provisional application No. 63/713,200, filed on Oct. 29, 2024.
(60) Provisional application No. 63/714,009, filed on Oct. 30, 2024.
(60) Provisional application No. 63/723,471, filed on Nov. 21, 2024.
(60) Provisional application No. 63/736,568, filed on Dec. 19, 2024.
(60) Provisional application No. 63/738,639, filed on Dec. 24, 2024.
(60) Provisional application No. 63/774,949, filed on Mar. 20, 2025.
(60) Provisional application No. 63/794,007, filed on Apr. 24, 2025.
(60) Provisional application No. 63/794,564, filed on Apr. 25, 2025.
(60) Provisional application No. 63/800,869, filed on May 6, 2025.
(60) Provisional application No. 63/822,629, filed on Jun. 12, 2025.
(60) Provisional application No. 63/925,068, filed on Nov. 25, 2025.

(51) Int. Cl. G06F 21/62

(52) U.S. Cl. CPC G06F 21/6209; G06F 21/6245

(57) ABSTRACT

A method may include tracking, by a self-administering document, fractional access rights to the self-administering document. The method may include receiving, at the self-administering document, a request to access the self-administering document. The method may include determining, based on the fractional access rights, that an entity making the request is allowed to access a subset of data associated with the document. The method may include providing, in response to the determination and via the self-administering document, access to the subset. Various additional systems and methods are also disclosed.

### PRIORITY CLAIMS TO RELATED APPLICATIONS

This application is a continuation application of and claims priority to International Patent Application No. PCT/US25/33602 filed Jun. 13, 2025, which claims priority to U.S. Provisional Patent Application No. 63/661,534 filed Jun. 18, 2024, U.S. Provisional Patent Application 63/668,068 filed Jul. 5, 2024, U.S. Provisional Patent Application 63/674,793 filed Jul. 23, 2024, U.S. Provisional Patent Application 63/680,061 filed Aug. 6, 2024, U.S. Provisional Patent Application 63/685,234 filed Aug. 20, 2024, U.S. Provisional Patent Application 63/693,173 filed Sep. 10, 2024, U.S. Provisional Patent Application 63/707,992, filed Oct. 16, 2024, U.S. Provisional Patent Application 63/713,200, filed Oct. 29, 2024, U.S. Provisional Patent Application 63/714,009 filed Oct. 30, 2024, U.S. Provisional Patent Application 63/723,471 filed Nov. 21, 2024, U.S. Provisional Patent Application 63/736,568, filed Dec. 19, 2024, U.S. Provisional Patent Application 63/738,639, filed Dec. 24, 2024, U.S. Provisional Patent Application 63/774,949, filed Mar. 20, 2025, U.S. Provisional Patent Application 63/794,007, filed Apr. 24, 2025, U.S. Provisional Patent Application 63/794,564, filed Apr. 25, 2025, U.S. Provisional Patent Application 63/800,869, filed May 6, 2025, and U.S. Provisional Patent Application 63/822,629 filed Jun. 12, 2025, each of which this application claims benefit to and priority to, and each of which are incorporated herein in their entirety by these references. This application also claims priority to and benefit of U.S. Provisional Patent Application 63/925,068, filed Nov. 25, 2025, U.S. Provisional Patent Application 63/943,892, filed Dec. 12, 2025, U.S. Provisional Patent Application 63/944,143, filed Dec. 12, 2025, U.S. Provisional Patent Application 63/962,034, filed Jan. 16, 2026, U.S. Provisional Patent Application 64/002,016, filed Mar. 10, 2026, and U.S. Provisional Patent Application 64/010,751, filed Mar. 19, 2026, each of which are incorporated herein in their entirety by these references.

### BACKGROUND

In the digital age, the management and control of electronic documents have become increasingly complex. Traditional document management systems often rely on centralized control mechanisms, which can be cumbersome and inflexible, especially in environments where documents need to be accessed by multiple users with varying levels of permissions. This has led to challenges in ensuring secure and efficient access to sensitive information, as well as difficulties in managing document versions and maintaining data integrity.

### SUMMARY

In some aspects, the techniques described herein relate to a method including: tracking, by a self-administering document, fractional access rights to the self-administering document; receiving, at the self-administering document, a request to access the self-administering document; determining, based on the fractional access rights, that an entity making the request is allowed to access a subset of data associated with the document; and providing, in response to the determination and via the self-administering document, access to the subset.

In some aspects, the techniques described herein relate to a system including: one or more physical processors; and physical memory including computer-executable instructions that, when executed by the one or more physical processors, cause at least one of the one or more physical processors to: track, by a self-administering document, fractional access rights to the self-administering document; receive, at the self-administering document, a request to access the self-administering document; determine, based on the fractional access rights, that an entity making the request is allowed to access a subset of data associated with the document; and provide, in response to the determination and via the self-administering document, access to the subset.

In some aspects, the techniques described herein relate to a non-transitory computer-readable medium including computer-executable instructions that, when executed by one or more physical processors of a computing device, cause the computing device to: track, by a self-administering document, fractional access rights to the self-administering document; receive, at the self-administering document, a request to access the self-administering document; determine, based on the fractional access rights, that an entity making the request is allowed to access a subset of data associated with the document; and provide, in response to the determination and via the self-administering document, access to the subset.

These and other features will be more clearly understood from the following detailed description taken in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a system architecture for managing electronic documents as smart digital objects, designed to facilitate fractional access control.

FIG. 2 illustrates a networked document management system, which demonstrates the interaction between various components involved in storing and accessing electronic documents.

FIG. 3 provides a flow chart of the method for self-administering documents detailing steps for tracking and enforcing fractional access rights.

FIG. 4 illustrates an example of managing fractional access with redaction.

FIG. 5 shows an example of managing fractional access by selectively displaying text.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

In the modern digital landscape, managing access to electronic documents has become a critical challenge, particularly when it comes to redaction and granular content control. Traditional electronic documents, such as PDFs or word processing files, often lack the inherent intelligence to autonomously manage access rights. Redaction, for instance, typically requires manual intervention, where sensitive information is blacked out or removed before sharing the document. This process is not only time-consuming but also prone to human error, as improperly redacted content can sometimes be recovered or exposed through technical means. Furthermore, traditional documents do not inherently support dynamic access control, meaning that once a document is shared, the sender loses control over how the recipient interacts with it. This lack of flexibility makes it difficult to enforce varying levels of access for different users, especially in environments where multiple stakeholders require access to distinct portions of the same document.

Self-administering documents offer a powerful solution to these challenges by enabling fractional access control. Unlike traditional documents, self-administering documents are embedded with intelligence that allows them to autonomously manage access rights. These documents can track fractional permissions, evaluate access requests, and provide selective access to specific subsets of data. For example, a self-administering document can determine that a user is authorized to view only certain sections of a financial report, such as sales figures, while restricting access to other sensitive data, such as payroll information. This capability is achieved without the need for manual redaction or external access control systems, as the document itself enforces the rules. By embedding access control mechanisms directly into the document, self-administering documents eliminate the need for centralized systems, reduce the risk of unauthorized access, and streamline the process of sharing sensitive information.

The advantages of fractional access control are numerous and far-reaching. First and foremost, it enhances security by ensuring that users can only access the information they are authorized to view. This is particularly valuable in industries such as healthcare, where patient privacy must be protected, or in government settings, where classified information must be restricted based on security clearance levels. Fractional access control also improves compliance with legal and regulatory requirements, such as the General Data Protection Regulation (GDPR) or the Health Insurance Portability and Accountability Act (HIPAA), by enabling organizations to enforce data access policies at a granular level. Additionally, self-administering documents can support subscription-based content delivery models, where users gain access to different tiers of information based on their subscription level. For instance, a basic subscriber might only see an executive summary, while a premium subscriber gains access to detailed analyses and proprietary insights.

Another significant advantage is the efficiency and scalability offered by self-administering documents. Traditional access control systems often rely on centralized servers to manage permissions, which can create bottlenecks and increase network congestion. In contrast, self-administering documents operate independently, reducing the load on central systems and enabling faster, more efficient access. This distributed approach also enhances scalability, as the document itself handles access requests without requiring constant communication with a central authority. Moreover, self-administering documents can dynamically adapt to changing access requirements. For example, if a user's role changes within an organization, the document can automatically update their access rights without requiring manual reconfiguration.

In addition to these technical benefits, fractional access control fosters greater collaboration and trust among users. By providing tailored access to specific subsets of information, self-administering documents enable stakeholders to work together more effectively without compromising sensitive data. For example, in a corporate setting, a financial report can be shared with multiple departments, with each team accessing only the data relevant to their responsibilities. This selective sharing not only protects confidentiality but also ensures that users are not overwhelmed with irrelevant information, thereby improving productivity.

In conclusion, the limitations of traditional electronic documents in managing redaction and granular content control highlight the need for more advanced solutions. Self-administering documents address these challenges by enabling fractional access control, offering a secure, efficient, and flexible framework for managing sensitive information. By embedding intelligence directly into the document, these systems enhance security, ensure compliance, and support a wide range of use cases, from subscription-based content delivery to role-based access in corporate environments. As organizations continue to navigate the complexities of the digital age, self-administering documents represent a significant step forward in the evolution of document management.

As noted, in today's digital landscape, the proliferation of electronic documents necessitates advanced methods for managing access and ensuring data security. Traditional document management systems often fall short in environments where multiple users require varying levels of access to sensitive information. The examples described herein address these challenges by introducing a method and system for fractional access control through self-administering documents. These documents are equipped with the capability to autonomously track and manage access rights, thereby providing a more flexible and secure approach to document management.

In some aspects, the methods and systems disclosed herein may determine access rights based on fractional permissions. When a request to access a self-administering document is received, the document evaluates the request against its access rules. This evaluation determines whether the requesting entity is permitted to access a specific subset of data within the document. By doing so, the document can selectively provide access to authorized users while safeguarding other portions of the document, which may be protected by paywalls or contain sensitive information such as personally identifiable data.

Furthermore, the systems and methods disclosed herein can incorporate mechanisms for redacting data and enforcing non-disclosure agreements. For instance, if a user does not have the necessary clearance, the document can automatically redact certain data subsets, ensuring that only authorized information is accessible. Additionally, the system can recognize and enforce non-disclosure agreements, allowing access to specific data subsets only to entities bound by such agreements. This approach can not only streamline document management, but can also bolster data protection and compliance with privacy regulations.

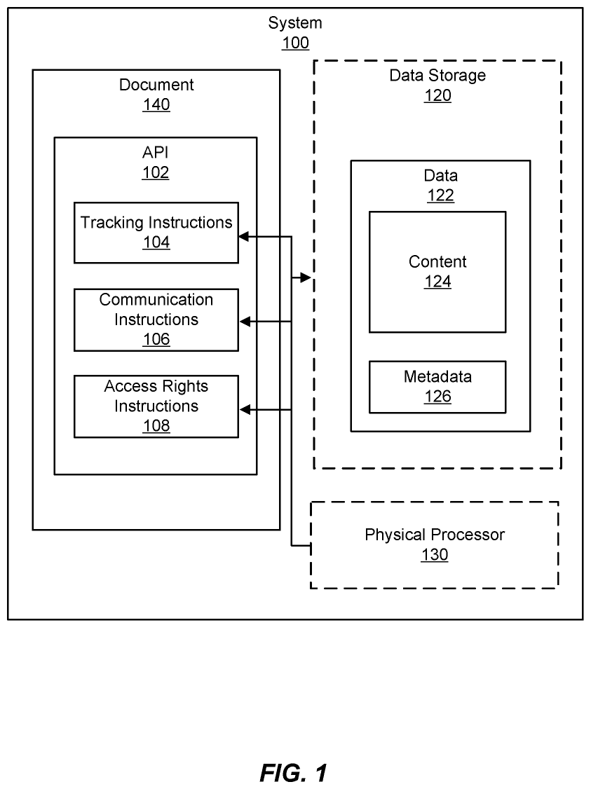

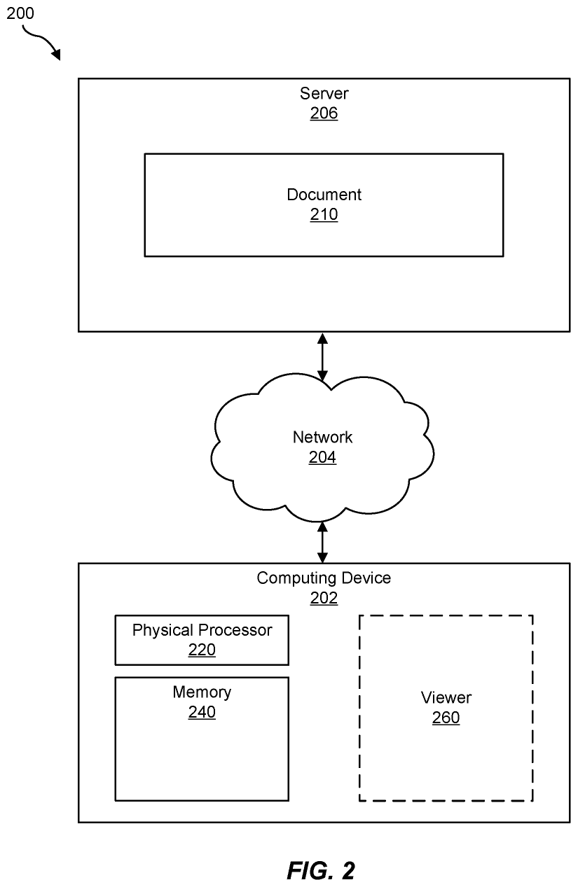

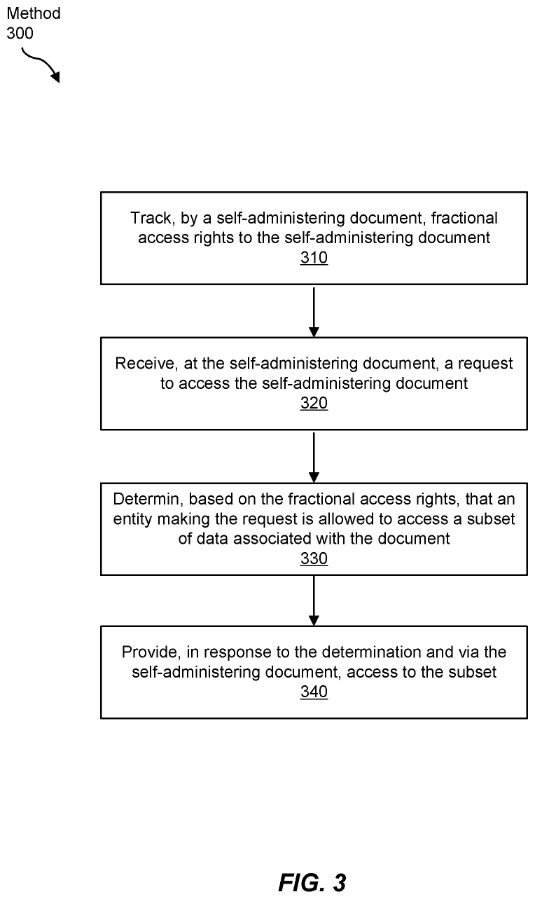

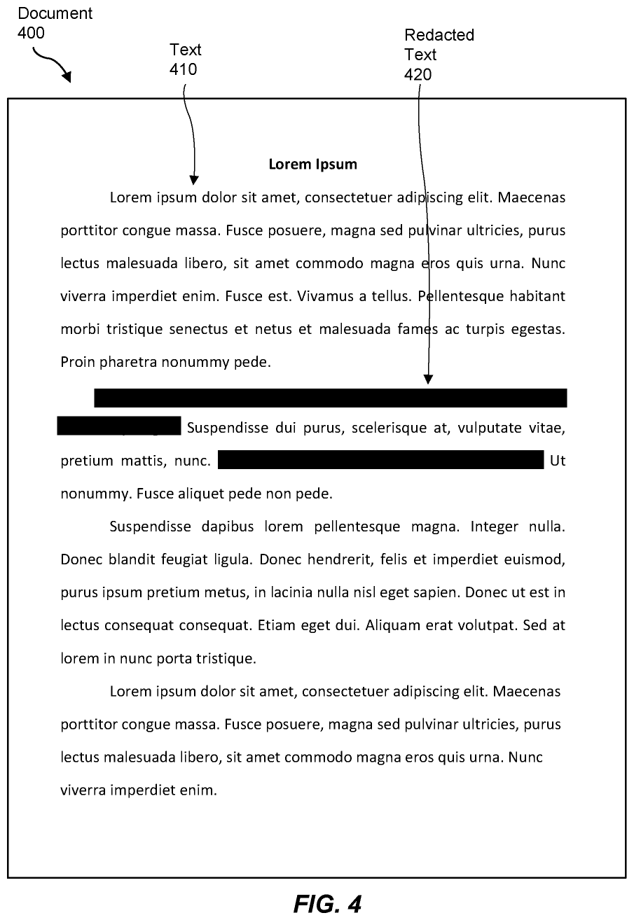

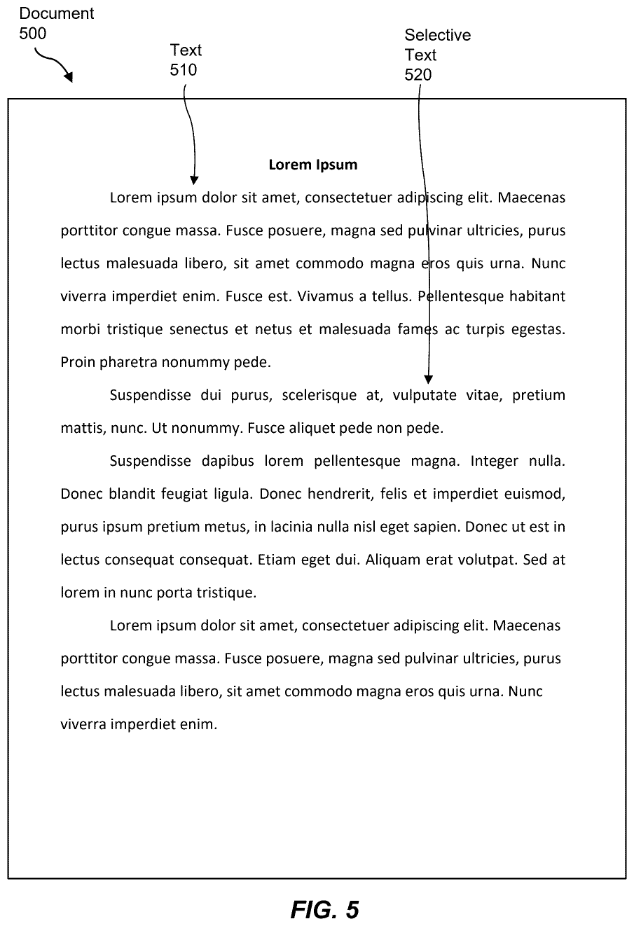

The figures accompanying this disclosure illustrate various aspects of the system and methods for managing electronic documents as self-administering digital objects with fractional access control. FIG. 1 presents the system architecture, and FIG. 2 depicts a networked document management system, showing the interaction between a computing device, server, and network for document storage and access. FIG. 3 provides a flow chart of the method for self-administering documents detailing steps for tracking and enforcing fractional access rights. FIG. 4 illustrates an example of managing fractional access with redaction, and FIG. 5 shows an example of managing fractional access by selectively displaying text.

FIG. 1 illustrates a system 100 for managing electronic documents as smart digital objects, designed to facilitate fractional access control. Document 140 shows a document that includes an Application Programming Interface (API) 102. While shown as a single API, the functionality of API 102 can be performed with any suitable code. Within the API there are three sets of instructions: the Tracking Instructions 104, the Communication Instructions 106, and the Access Rights Instructions 108. The Tracking Instructions 104 perform monitoring and recording access activities related to the document, ensuring that all interactions are logged for security and auditing purposes. The Communication Instructions 106 facilitate the exchange of information between the document and external systems or users, allowing for seamless integration with existing document management systems. The Access Rights Instructions 108 are crucial for evaluating access requests and determining the appropriate level of access based on predefined rules and conditions.

The system also includes a Data Storage component 120, which securely houses the Data 122 associated with the documents. This storage component is designed to maintain the integrity and confidentiality of the document's content. Additionally, the Physical Processor 130 is responsible for executing the instructions necessary for the operation of the system, including processing access requests and enforcing access rules. Together, these components form a system that supports the creation and management of self-administering documents, providing a robust solution for fractional access control and enhanced document security.

In some examples, the data of a self-determinative document can include two distinct components: content 124 and metadata 126, each serving a unique purpose in the document's functionality and lifecycle. Content 124 refers to the core information of the document, such as text, images, tables, or other embedded elements that constitute the primary substance of the document. This content is immutable, meaning it cannot be altered once the document has been finalized or authenticated. The immutability of content 124 ensures the integrity and trustworthiness of the document, making it suitable for applications where the original state of the document must be preserved, such as legal agreements, financial reports, or medical records.

On the other hand, metadata 126 represents supplementary information about the document, such as timestamps, user interactions, access logs, version history, or contextual details. Unlike the immutable content, metadata 126 is mutable and can be updated or modified as the document evolves. For example, metadata can record the identity of users who accessed the document, the time and date of interactions, or the addition of comments or annotations. This mutability allows the document to dynamically track its lifecycle and provide real-time insights into its usage and provenance. By separating immutable content from mutable metadata, the document achieves a balance between preserving its core integrity and enabling flexibility for operational and contextual updates. This dual structure ensures that the document remains both reliable and adaptable, meeting the needs of secure and dynamic digital environments.

Metadata plays a central role in the functionality and transformative potential of smart documents (i.e., documents that are digital infrastructure). It provides a structured, machine-readable layer of information that goes beyond the visual representation of a document, enabling advanced computational interactions, dynamic workflows, and granular access control. Metadata can be categorized into several distinct types, each serving a unique purpose in enhancing the utility and intelligence of a document. These categories include process metadata, semantic metadata, and content-related metadata, among others. Below is a detailed explanation of these metadata types, with examples drawn from the discussion.

Process metadata captures the history and lifecycle of a document, recording every action, interaction, and workflow the document has undergone. This type of metadata serves as an audit trail, providing a comprehensive record of the document's journey and the processes it has been part of. For example, process metadata might include timestamps for when the document was created, edited, shared, or signed. It could also log the identities of users who accessed the document, the nature of their interactions (e.g., viewing, commenting, or editing), and any changes made to the document's content or metadata.

Semantic metadata describes the intrinsic characteristics of a document, answering the question of “what the document is” rather than “what the document contains.” This type of metadata includes information about the document's type, ownership, and categorical classification. For example, semantic metadata might indicate that a document is an NDA (Non-Disclosure Agreement), a marketing presentation, or a financial report. It might also specify the document's owner, such as the individual or organization responsible for its creation and management.

Semantic metadata is particularly useful for organizing and categorizing documents within a system. For instance, in an enterprise setting, semantic metadata can be used to group all contracts under a “Legal Documents” category, all invoices under a “Finance Documents” category, and all marketing materials under a “Marketing Documents” category. This categorization enables efficient search and retrieval, as users can query the system to find all documents of a specific type or category.

Content-related metadata provides a structured representation of the document's content, breaking it down into machine-readable elements such as paragraphs, headings, tables, and images. This type of metadata enables advanced computational interactions with the document, such as semantic analysis, automated workflows, and dynamic rendering.

FIG. 2 illustrates a networked document management system, which demonstrates the interaction between various components involved in storing and accessing electronic documents. The system 200 includes a Server 206, which houses the Document 210. This server is connected to a Network 204, facilitating communication and data transfer between the server and other devices.

A Computing Device 202 is shown as part of the system, equipped with a Physical Processor 220 and Memory 240. The physical processor is responsible for executing instructions and processing data, while the memory stores the necessary data and instructions for document management. The computing device also includes a Viewer 260, which allows users to access and interact with the documents stored on the server.

The networked system depicted in FIG. 2 enables efficient document management by allowing documents to be stored on a central server and accessed remotely via the network. This setup supports the implementation of self-administering documents, as it provides the necessary infrastructure for managing access rights and ensuring secure data exchange between the server and computing devices.

FIG. 3 provides a flow chart diagram illustrating a method for creating and managing a self-administering document with embedded intelligence, designed to autonomously handle fractional access rights.

Step 310 in FIG. 3 involves tracking, by a self-administering document, fractional access rights to the document. This step may ensure that the document can autonomously manage who has access to specific portions of its content. The tracking process can be performed in any suitable manner.

In some aspects, tracking rights can be performed by the self-administering document in interactions with an administrator. Administrators can interact with the self-administering document to define access permissions for various users, groups, or roles. These permissions are then stored within or otherwise associated with the document, enabling it to enforce access rules autonomously. For example, an administrator may configure access rights for a financial report, granting analysts access to revenue data while restricting marketing managers to sales data.

As noted, tracking rights can involve storing the rights within the self-administering document or otherwise (e.g., as metadata). This ensures that the document can quickly reference and apply these rights when evaluating access requests. The embedded intelligence within the self-administering document enables it to maintain a record of access permissions that can be updated as needed.

In some aspects, rights can be tracked by detecting rights based on user roles. The document can automatically recognize the role of a user attempting to access it and apply the corresponding access rights. For instance, a document can detect that a user is part of the executive team and grant them access to strategic sections, while limiting other users to less sensitive content.

In some aspects, a self-administering document can track rights by identifying rights of a traditional document that was converted into the self-administering document. This process involves recognizing the existing access rights and permissions that were originally set for the traditional document and integrating them into the self-administering document's framework. For example, when a traditional document is converted into a self-administering document, the self-administering document can identify the access rights that were previously established. These rights might include user-specific permissions, group-based access, or role-based restrictions that were defined in the original document management system. The self-administering document then assimilates these rights, enabling it to autonomously enforce them without requiring manual reconfiguration.

Tracking access rights in a self-administering document can involve various mechanisms to ensure that only authorized entities can access specific content. This includes tracking whether entities have signed Non-Disclosure Agreements (NDAs), tracking security clearances, and tracking subscriptions, among other criteria. Tracking NDAs involves the document verifying whether an entity requesting access has signed an NDA, which legally obligates them to maintain confidentiality regarding the information they access. For example, a self-administering document containing proprietary business strategies can verify that a potential business partner has signed an NDA before granting access to strategic sections. Similarly, in a research collaboration, a self-administering document can check that a collaborating scientist has signed an NDA related to the project before allowing access to experimental data. In another example, a government document containing classified information might grant access to different sections based on whether the requester has “Confidential,” “Secret,” or “Top Secret” clearance, thereby protecting national security.

In some examples, tracking subscriptions can be performed by a self-determining document. The document may determine access-rights based on the user's subscription level, offering fractional access accordingly. For example, a digital publishing platform can provide basic subscribers access to general industry trends, while premium subscribers can view detailed analyses and proprietary forecasts.

In some examples, tracking user roles can also enable a self-administering document to automatically recognize the role of a user attempting to access it and apply the corresponding access rights. For instance, in a corporate setting, a document might detect that a user is part of the executive team and grant them access to strategic sections while limiting other users to less sensitive content.

In some examples, tracking group memberships enables a self-administering document to grant access based on whether a user belongs to a specific group or department. For example, a document might allow members of the finance department to access all financial data, while restricting sales department members to sales figures only.

Tracking project involvement can include the self-determining document determining whether a user is involved in a particular project and granting access to project-related documents. For instance, a self-administering document can allow access to project plans and reports only to team members actively working on the project.

As another example, consider a traditional document containing sensitive legal information that has specific access rights set for different legal teams. Upon conversion to a self-administering document, these access rights are identified and preserved, ensuring that the same teams continue to have access to the relevant sections of the document. This capability streamlines the transition from traditional to self-administering documents, maintaining continuity in access control and enhancing security by leveraging existing permissions.

As another example, in healthcare, traditional patient records can have access rights based on medical roles, where doctors have full access to patient histories, nurses can view current treatment plans, and administrative staff can access billing information. Upon conversion to self-administering documents, these role-based access rights are identified and maintained, ensuring compliance with healthcare regulations and patient confidentiality.

In a corporate environment, financial reports can have access rights configured for different departments, such as finance having access to all financial data, sales viewing only sales figures, and HR accessing payroll information. When these reports are converted, the existing access rights are preserved, enabling each department to continue accessing relevant data without compromising confidentiality.

In educational institutions, traditional documents like course materials and student records can have access rights set for faculty, students, and administrative staff. Faculty can access all course materials and student grades, students can view their own grades and course content, and administrative staff can access enrollment information. Upon conversion to self-administering documents, these access rights can be maintained, ensuring that faculty, students, and staff continue to access only the information they are authorized to view, thereby protecting student privacy and maintaining the integrity of academic records.

By employing one or more of these tracking mechanisms, the self-administering document can effectively manage access rights, ensuring that sensitive information is protected and only accessible to authorized entities. This approach may enhance security, compliance, and/or the efficient management of document access.

A “self-administering document” refers to a type of electronic document embedded with intelligence that enables it to autonomously manage its lifecycle, interactions, and access permissions. Unlike traditional documents, which rely on external systems or manual input for management, self-administering documents are designed to independently regulate and enforce rules governing their use, access, and modification. These documents actively monitor events such as access attempts, modifications, and interactions with other systems, and dynamically respond to these events based on predefined conditions.

The embedded intelligence within a self-administering document allows it to maintain a comprehensive audit trail, capturing detailed information about who accessed the document, when it was accessed, and what actions were performed. This capability ensures compliance with regulatory requirements and organizational policies by providing a reliable and tamper-proof record of all document-related activities. The audit trail is inseparable from the document itself, ensuring transparency and accountability throughout its lifecycle.

Self-administering documents enhance security by autonomously managing access permissions through mechanisms such as role-based access control, encryption, and multi-factor authentication. These documents can dynamically grant or revoke access based on user roles, subscription levels, or other contextual factors, ensuring that only authorized users can interact with the document. By transforming documents into active entities capable of self-regulation, organizations can significantly reduce the risk of unauthorized access and data breaches while streamlining document management processes and maintaining data integrity. A self-administering document is composed of code (i.e., intelligence), content, and metadata, which together enable its autonomous functionalities.

In some examples, a self-administering document represents a transformative innovation in digital information management, designed to autonomously enforce rules and manage its own lifecycle, interactions, and provenance. Unlike traditional documents, which depend on external systems for governance, a self-administering document embeds intelligence directly within itself, enabling it to function as an active entity. This embedded intelligence allows the document to independently identify events, such as access requests, modifications, or interactions with other systems, and respond to these events in accordance with its embedded rules. By doing so, the document ensures compliance, security, and accountability while maintaining a detailed record of its interactions.

The attributes of a self-administering document are multifaceted and address the limitations of traditional document management systems. First, a self-administering document is uniquely addressable, possessing a permanent and immutable identifier that distinguishes it from all other documents. This identifier ensures reliable access and referencing, regardless of the document's location or the number of copies in existence. Additionally, the document is equipped with machine-readable metadata that captures detailed information about its interactions, such as timestamps, user credentials, geolocation data, and the nature of the interaction. This metadata is structured to support automated processing and analysis, enabling advanced functionalities such as real-time auditing, compliance verification, and dynamic access control.

Another attribute of a self-administering document is its ability to enforce version control. When changes are required, the document creates a new uniquely addressable version rather than altering the original. This approach preserves the integrity of the original document while providing a clear record of its evolution. Each version is assigned its own unique identifier, ensuring independent access and verification. The relationship between versions is recorded, creating a hierarchical structure that allows users to trace the document's history and understand the context of each modification. For example, if a contract is updated to include new terms, the updated version references the original, enabling auditors to compare the two and verify the changes.

The creation of new versions is governed by strict rules and cryptographic mechanisms to ensure authenticity and prevent unauthorized modifications. When a user or system initiates a change, the self-administering document generates a cryptographic signature that validates the modification and ties it to the new version. This signature is stored as part of the document's metadata, providing a tamper-proof record of the change. Additionally, the document's embedded intelligence ensures that all changes are logged in its audit trail, capturing details such as who made the change, when it was made, and why it was made. This level of detail supports transparency and enhances security by making unauthorized alterations virtually impossible.

The immutability of the content in a self-administering document is a foundational characteristic that ensures the integrity, reliability, and trustworthiness of the document throughout its lifecycle. This immutability is achieved through technical mechanisms and design principles, as explained below.

The “content” of a self-administering document refers to the core information that constitutes the document, such as text, images, tables, or other embedded elements. This content is distinct from metadata (which provides supplementary information about the document, such as timestamps, user interactions, and version history) and executable code (which enables the document's intelligent functionalities). Immutability applies specifically to the content, ensuring that it remains unchanged once the document is finalized or authenticated.

To ensure immutability, the content of a self-administering document can be cryptographically hashed at the time of its creation or finalization. A cryptographic hash is a unique, fixed-length string generated from the content using a hashing algorithm (e.g., SHA-256). This hash acts as a digital fingerprint of the content. If even a single character or pixel in the content is altered, the hash will change, making it immediately evident that the content has been tampered with.

Any system or user accessing the document can verify its integrity by recalculating the hash and comparing it to the original hash stored in the document's metadata. If the hashes match, the content is confirmed to be unchanged.

In cases where changes to the document are necessary (e.g., updates or amendments), the self-administering document does not alter the original content. Instead, it creates a new version of the document with its own unique identifier and cryptographic hash. The original version remains intact and accessible, ensuring that the history of the document is preserved.

Each version of the document is uniquely addressable and linked to previous versions, creating a hierarchical structure that allows users to trace the evolution of the document. This approach ensures that the original content is never overwritten or lost.

In some embodiments, the self-administering document may leverage distributed ledger technology to ensure immutability. The content and its associated hash can be recorded on a distributed ledger, where each entry is cryptographically secured and immutable. This approach provides an additional layer of protection, as the blockchain ensures that the content cannot be altered without consensus from the network.

The self-administering document separates its content from other mutable elements, such as metadata and executable code. While metadata and code can be updated to reflect new interactions or functionalities, the content layer remains fixed and unchangeable. This separation ensures that the core information of the document is preserved, even as the document evolves in other ways.

The self-administering document provides transparency to users by enabling them to verify the authenticity and integrity of the content at any time. This transparency is achieved through audit trails and visual indicators, ensuring that users can trust the document's reliability and security.

Step 320 in FIG. 3 involves the process of receiving a request to access the self-administering document. This step can initiate the interaction between the user and the document, setting the stage for the document to evaluate the request based on its embedded access rights. When a user or entity attempts to access the document, the request is captured by the self-administering document, which identifies the requester and the specific data subset they wish to access.

As an example, in a law firm, a self-administering document containing sensitive legal information can receive an access request from a junior associate. The document captures the request, noting the associate's role and the specific sections of the document they wish to access. In a hospital setting, a self-administering document containing patient records may receive an access request from a nurse. The document logs the request, identifying the nurse's role and the particular patient information they are attempting to access. Within a corporation, a self-administering document containing financial reports may receive an access request from a sales manager. The document may record the request, detailing the manager's role and the financial data they seek to view. In a university, a self-administering document containing course materials may receive an access request from a student. The document may register the request, recognizing the student's role and the specific grades or course content they are trying to access.

An access request to a self-administering document can vary in scope, depending on the user's needs and permissions. In some cases, the request may be for fractional access, where the user seeks to access only specific parts of the document. This type of request is common in environments where users have distinct roles and responsibilities, necessitating access to particular sections of a document relevant to their tasks. For example, a financial analyst might request access only to the revenue data section of a financial report, while a marketing manager might request access solely to sales figures. A self-administering document can process these requests by evaluating the user's credentials and role against its embedded access rights, granting access to the requested sections if permissions align.

Conversely, an access request can also be a request to access an entire document, typically made by users with broader responsibilities or higher clearance levels. For instance, a CEO might request access to the full strategic plan document to review all aspects of the company's direction, or a principal investigator in a research setting might need access to all data sets within a research document. The self-administering document evaluates these requests, ensuring that the user's permissions allow for full access before granting them. If a user does not have full access to the document, fractional access may be allowed depending on the user's access rights. This flexibility in handling access requests ensures that documents can cater to diverse user needs while maintaining security and compliance with access policies.

As an example of a request, in a law firm, a self-administering document containing sensitive legal information may receive a fractional access request from a junior associate. The document captures the request, noting the associate's role and the specific sections of the document they wish to access or are allowed to access, such as case research notes. In a hospital setting, a self-administering document containing patient records may receive an access request from a nurse. The document logs the request, identifying the nurse's role and the particular patient information they are attempting to access, such as current treatment plans.

Within a corporation, a self-administering document containing financial reports may receive a fractional access request from a sales manager. The document records the request, detailing the manager's role and the specific financial data they seek to view. In a university, a self-administering document containing course materials may receive a fractional access request from a student. The document registers the request, recognizing the student's role and the specific grades or course content they are trying to access, while other students' grades and faculty-only materials are not included in the request.

Step 330 involves determining whether the entity making the access request is allowed to access a specific subset of data within the self-administering document. This step ensures that the document's embedded access rights are enforced accurately. Upon receiving an access request, the document evaluates the request against its stored access permissions, which may have been predefined by administrators or set in any other suitable manner. This evaluation process involves checking the requester's credentials, role, and the specific data subset they wish to access. By doing so, the document can ascertain whether the requester has the necessary permissions to view the desired content.

In a law firm example, the document can assess a junior associate's request to access case research notes. It checks the associate's role against the predefined access permissions and, if the associate is authorized, grants access to the requested sections while restricting access to more sensitive client information reserved for senior partners. In the hospital setting, the document evaluates the nurse's request to access current treatment plans. It verifies the nurse's role and permissions, granting access to the treatment plans if the nurse is authorized, while ensuring that access to full patient histories remains restricted to doctors.

Within a corporation, a self-administering document can process a sales manager's request to view specific financial data, such as sales figures. It compares the manager's role with the stored access rights and, if authorized, allows access to the requested financial data while keeping other sensitive financial information, like overall revenue, inaccessible. In a university scenario, a self-administering document can review the student's request to access their own grades and course content. It checks the student's role and permissions, granting access to the requested information if authorized, while ensuring that other students' grades and faculty-only materials remain protected and inaccessible.

In a digital publishing platform, a self-administering document can contain a comprehensive market analysis report. The document can be designed to offer fractional access to different types or amounts of content based on subscription tiers, effectively placing certain sections behind a paywall. For instance, a basic subscriber may request access to the document and be granted access only to the executive summary and general industry trends sections. These sections provide a high-level overview of the market without delving into detailed data or proprietary insights. A premium subscriber, on the other hand, might request access to the same document and be allowed to view additional sections, such as detailed statistical analyses, proprietary market forecasts, and competitive intelligence. These sections contain more in-depth information and insights that are reserved for higher-tier subscribers. A self-administering document can evaluate each access request against a subscriber's tier and permissions, ensuring that the content provided aligns with the subscription level. This approach not only monetizes the content effectively but also ensures that users receive information tailored to their subscription, maintaining the integrity and value of the document's content.

In a government agency, a self-administering document may contain classified information related to national security. The document can be designed to offer fractional access based on the security clearance level of the personnel requesting access. For example, an employee with a “Confidential” clearance level may request access to the document and be granted access only to sections containing general information and non-sensitive confidential data. These sections might include summaries of past operations or general policy guidelines that do not compromise security. An employee with a “Secret” clearance level may request access to the same document and be allowed to view additional sections containing more sensitive information, such as detailed operational plans or intelligence reports. These sections provide deeper insights into ongoing operations and are reserved for personnel with higher clearance.

Finally, an employee with a “Top Secret” clearance level may request access and be granted full access to the document, including the most sensitive sections that contain critical intelligence, strategic plans, and other high-security data. The self-administering document can evaluate each access request against the employee's clearance level, ensuring that the information provided aligns with their security authorization. This approach ensures that sensitive information is protected and only accessible to personnel with the appropriate clearance, maintaining national security and compliance with security protocols.

In some examples, fractional access can be based on whether an entity requesting access has signed a Non-Disclosure Agreement (NDA). Such examples may involve the self-administering document evaluating the legal obligations of the requester before granting access to specific content. This mechanism ensures that sensitive information is only accessible to entities that are legally bound to maintain confidentiality. For instance, a self-administering document containing proprietary business strategies might receive an access request from a potential business partner. The document first checks whether the partner has signed an NDA that covers the specific strategies and data within the document. If the NDA is verified, the document grants access to sections containing strategic plans and proprietary insights, while other sections remain restricted. If the NDA is also a self-administering document, verification may be performed via a back-and-forth communication with the NDA.

Similarly, in a research collaboration, a self-administering document containing experimental data may receive an access request from a collaborating scientist. The document evaluates whether the scientist has signed an NDA related to the research project. If the NDA is in place, the document allows access to detailed experimental results and methodologies, ensuring that the information is shared only with parties committed to confidentiality.

By incorporating NDA verification into the access control process, the self-administering document can safeguard sensitive information, ensuring that it is only shared with entities that have agreed to protect the confidentiality of the data. This approach not only enhances security but also facilitates compliance with legal agreements and protects intellectual property.

Step 340 involves the process of providing access to a specific subset of data within the self-administering document, following the determination that the entity making the request is authorized to access it. This step is crucial for ensuring that the document's embedded access rights are enforced accurately and that sensitive information is protected. Once the document has evaluated the access request and confirmed the requester's permissions, it grants access to the authorized data subset. This selective access ensures that users can view the information relevant to their roles or responsibilities while safeguarding other portions of the document that may contain sensitive or restricted content. By providing access in this manner, the self-administering document maintains security and compliance with organizational policies and external regulations, ensuring that only authorized users can access specific information.

In a law firm example, once a self-administering document has assessed a junior associate's request to access case research notes and confirmed their authorization, step 340 involves granting the associate access to the requested sections. The document ensures that the associate can view the case research notes while restricting access to more sensitive client information, which remains reserved for senior partners. This selective access maintains confidentiality and compliance with legal standards.

In a hospital setting, after evaluating a nurse's request to access current treatment plans and verifying their role and permissions, a self-administering document grants access to the treatment plans. Step 340 ensures that the nurse can view the necessary information for patient care, while access to full patient histories is restricted to doctors, thereby maintaining patient privacy and adhering to healthcare regulations.

Within a corporation, once a self-administering document processes a sales manager's request to view specific financial data and confirms their authorization, step 340 involves granting access to the requested sales figures. The document ensures that the manager can access relevant financial data while keeping other sensitive information, such as overall revenue, inaccessible, thus protecting the company's financial confidentiality.

In the university scenario, after reviewing a student's request to access their own grades and course content and confirming their permissions, the document grants access to the requested information. Step 340 ensures that the student can view their grades and course materials while safeguarding other students' grades and faculty-only materials, thereby protecting student privacy and maintaining academic integrity.

In a digital publishing platform, once the document evaluates a subscriber's request and confirms their subscription tier, step 340 involves granting access to content aligned with their subscription level. For a basic subscriber, this might mean access to the executive summary and general industry trends, while a premium subscriber could access detailed statistical analyses and proprietary forecasts. This approach can monetize content effectively and ensures users receive information tailored to their subscription.

In a government agency, after evaluating an employee's request based on their security clearance level, step 340 involves granting access to sections of the document that align with their clearance. An employee with “Confidential” clearance might access general information, while those with “Secret” or “Top Secret” may be granted access to more sensitive sections. This ensures that sensitive information is protected and only accessible to personnel with the appropriate clearance, maintaining national security.

For fractional access based on NDAs, once the document verifies that an entity has signed an NDA, step 340 involves granting access to specific content covered by the agreement. For example, a business partner with a verified NDA might access strategic plans, while other sections remain restricted. Similarly, a collaborating scientist with an NDA might access experimental data, ensuring that sensitive information is shared only with parties committed to confidentiality.

FIG. 4 illustrates an example of providing fractional access to a document through the use of redaction. In this figure, document 400, contains both visible text, indicated by 410, and redacted text, indicated by 420. The redacted sections demonstrate how certain portions of a document can be obscured or hidden from view, allowing only authorized users to access specific content while protecting sensitive information.

In a legal context, redaction is often used in compliance with protective orders. For example, during litigation, a self-administering document might contain sensitive client information or trade secrets that are subject to a protective order. The document can redact these sections for parties who do not have the necessary clearance, ensuring that only authorized legal teams can view the full content. This approach can maintain confidentiality and complies with court-mandated restrictions.

In the context of Non-Disclosure Agreements (NDAs), redaction can be employed to protect proprietary information. A self-administering document containing business strategies might redact sections that include proprietary data for users who have not signed an NDA. Only those who have agreed to the NDA terms would have access to the complete document, safeguarding the company's intellectual property.

Redaction is also relevant in other contexts, such as government documents containing classified information. For instance, a document might redact sections with sensitive intelligence data for personnel without the appropriate security clearance. Similarly, in healthcare, patient records might be redacted to hide personal health information from administrative staff, allowing only medical professionals to access the full details. By using redaction, self-administering documents can effectively manage fractional access, ensuring that sensitive information is protected while still providing necessary access to authorized users.

FIG. 5 illustrates an example of providing fractional access to a document by selectively displaying text to which a user has access rights, rather than redacting portions of the document. The document, labeled as 500, contains text 510, and sections of text 510 are only shown selectively as selective text 520. Unlike redaction, where restricted text is obscured or marked as inaccessible, FIG. 5 shows how the text that would have been redacted is simply not shown to the user at all. This approach ensures that users only see the content they are authorized to access, without any indication that additional content exists. For instance, in a corporate setting, a self-administering document containing financial data might display only the sales figures to a sales manager, while omitting sections related to overall revenue or payroll information. The manager would see only the relevant data, with no visible indication that other sections of the document are inaccessible.

Similarly, in a legal context, a junior associate accessing a self-administering document may see only case research notes, while a self-administering document omits sensitive client information reserved for senior partners from view. This ensures that the associate interacts only with the content they are authorized to access, maintaining confidentiality without revealing the existence of restricted sections.

In a healthcare scenario, a nurse accessing patient records might see only current treatment plans, while full patient histories reserved for doctors are not displayed by a self-administering document. This approach protects patient privacy by ensuring that unauthorized users are unaware of the existence of additional sensitive information.

A self-administering document autonomously manages version-level access rights by embedding intelligence that tracks and enforces permissions for specific versions of the document. When a user requests access, the document evaluates the request against its internal rules to determine whether the user is authorized to view a particular version. For example, earlier drafts of a legal contract may be accessible to all collaborators, while the final version is restricted to senior management or legal counsel. The self-administering document ensures that only authorized users can access specific versions, protecting sensitive information and maintaining compliance with organizational policies.

The document also maintains a comprehensive audit trail, recording all interactions with each version. This audit trail allows organizations to track who accessed which version and when, ensuring accountability and transparency. By dynamically adjusting permissions based on the document's lifecycle stage, the self-administering document enhances security, streamlines workflows, and supports compliance with industry regulations.

A self-administering document extends its access control capabilities to attachments by embedding intelligence that manages permissions for supplementary content, such as raw data, images, or supporting documents. When a user attempts to access an attachment, the document evaluates the request and determines whether the user is authorized based on predefined rules. For example, a financial report might include an attachment with detailed budget spreadsheets, accessible only to the finance team. The document ensures that sensitive information within attachments remains protected.

Dynamic access control for attachments is also supported, allowing permissions to evolve based on user actions or the document's lifecycle stage. For instance, during the review phase of a project proposal, an attachment containing proprietary data might be accessible only to internal stakeholders. Once the proposal is approved, access to the attachment can be expanded to include external collaborators. The self-administering document autonomously enforces these rules, reducing complexity and enhancing security.

Additionally, the document provides a detailed audit trail for attachments, recording all interactions to ensure accountability and transparency. By integrating attachment access control directly into the document, organizations can maintain a unified framework for managing permissions across both the document and its associated content.

A self-administering document manages access to embedded applications within the document by dynamically adjusting permissions based on user roles and actions. These in-document apps can perform tasks such as facilitating signatures, managing workflows, or conducting audits. For example, a document might include an embedded app for collecting electronic signatures, accessible only to authorized signatories. The document evaluates each user's credentials and determines whether they are permitted to interact with the app.

The document also supports distinct access levels for different stakeholders. For instance, a due diligence questionnaire might include an app for assigning tasks to team members, accessible only to the team lead, while another app for submitting responses might be available to all team members. By tailoring access rights to the specific needs of each user, the self-administering document enhances security, streamlines workflows, and supports compliance with organizational policies.

Furthermore, the document maintains an audit trail for all interactions with embedded applications, ensuring accountability and transparency. This capability allows organizations to track who used which app and for what purpose, making it an essential feature for modern document management systems.

A self-administering document autonomously enforces rule-based access control by evaluating permissions based on predefined rules. These rules can be based on factors such as user identity, geographic location, or document lifecycle stage. For example, a document containing sensitive financial data might only be accessible to users within the finance department and located within the organization's network. The document dynamically applies these rules to ensure that access is aligned with organizational policies.

The document also supports complex and layered rules for granular access control. For instance, a marketing campaign document might initially be accessible only to the marketing team but later expanded to include external collaborators once the campaign is approved. The self-administering document automatically updates permissions based on the document's status, streamlining workflows and enhancing security.

By maintaining a detailed audit trail of all access attempts and interactions, the document ensures accountability and transparency. This approach eliminates the risk of human error in granting or revoking access and provides a secure framework for managing sensitive information in dynamic and collaborative environments.

A self-administering document enables fractional access to metadata by autonomously managing permissions for specific subsets of the document's metadata. When a user requests access, the document evaluates the request and determines whether the user is authorized to view particular metadata, such as the document's timeline, creation dates, or modification records. For example, a project manager might have access to the timeline of a document to track its progress, while other users are restricted from viewing this information.

The document dynamically adjusts metadata access permissions based on user roles or the document's lifecycle stage. For instance, a legal document might include metadata detailing its revision history, accessible only to senior legal counsel. By embedding fractional access control directly into the document, the self-administering document ensures that sensitive metadata remains protected while still enabling collaboration.

Additionally, the document maintains an audit trail for all interactions with metadata, recording who accessed which subsets and when. This ensures accountability and transparency, making fractional access to metadata an effective solution for managing sensitive information in a secure and compliant manner.

A self-administering document facilitates AB testing by autonomously managing two distinct versions of the document for comparative analysis. When a user requests access, the document determines which version they are authorized to view based on predefined permissions. For example, a marketing team might create two versions of a product brochure, each with different layouts or messaging, to determine which version resonates more effectively with the target audience. The document ensures that users only interact with the version they are permitted to access.

The document also tracks user interactions with both versions, providing insights into user behavior and preferences. By embedding AB testing functionality directly into the document, organizations can conduct comparative analysis without duplicating efforts or compromising security.

Furthermore, the document maintains a detailed audit trail for all interactions with both versions, ensuring accountability and transparency. This capability enhances decision-making, supports collaboration, and protects sensitive information, making AB testing an essential feature for modern document management systems.

A self-administering document enables redaction through its user interface, allowing users to obscure or remove sensitive information without altering the underlying content. When a user selects specific sections of the document for redaction, the document applies the changes dynamically, ensuring that redacted information is inaccessible to unauthorized users. For example, a legal team might redact client names and sensitive details from a document before sharing it with external parties.

The document also tailors redaction functionality to specific user roles, allowing different levels of access to the redacted content based on permissions. For instance, a healthcare document might allow doctors to view patient histories while restricting access to billing information. By embedding redaction functionality directly into the user interface, the self-administering document streamlines workflows and enhances security.

Additionally, the document maintains an audit trail for all interactions with redacted content, recording who performed the redaction and when. This ensures accountability and transparency, making redaction through the user interface an effective solution for managing sensitive information in collaborative and regulated environments.

A self-administering document autonomously enforces rule-based fractional access by evaluating permissions for specific portions of the document based on predefined rules. When a user requests access, the document determines whether they are authorized to interact with particular sections of the content. For example, a financial report might allow analysts to view revenue data while restricting access to payroll information.

The document dynamically adjusts fractional access permissions based on user identity, geographic location, or document lifecycle stage. For instance, a healthcare document might allow doctors to view patient histories while restricting access to billing information. By embedding rule-based fractional access directly into the document, the self-administering document ensures that permissions are updated automatically, streamlining workflows and reducing the risk of unauthorized interactions.

The document also maintains a detailed audit trail for all fractional access interactions, recording who accessed which sections and when. This ensures accountability and transparency, making rule-based fractional access an effective solution for managing sensitive information in dynamic and collaborative environments.

A self-administering document manages AI agent fractional access by autonomously evaluating permissions for specific portions of the document. When an AI agent requests access, the document determines whether the agent is authorized to interact with particular sections of the content. For example, an AI agent tasked with analyzing sales data might be granted access only to the revenue section of a financial report, while other sections remain restricted.

The document ensures that AI agents interact only with the content relevant to their tasks, reducing the risk of unauthorized data exposure and enhancing security. Additionally, the document maintains an audit trail for all interactions between AI agents and the document, recording which agents accessed which portions and for what purpose.

By embedding fractional access control directly into the document, the self-administering document enhances the utility of artificial intelligence, supports compliance, and protects sensitive information. This capability is particularly valuable in environments where AI systems play a critical role in decision-making and analysis.

A smart document is designed to ensure the integrity, authenticity, and traceability of its content and associated audit trail through the use of immutability, a global marker, and embedded intelligence. This innovative structure addresses longstanding challenges in document management, auditing, and compliance.

### Immutable Content

The content of a smart document is immutable, meaning it cannot be altered once finalized. This immutability is achieved through cryptographic techniques, such as hashing and digital signatures. When the document is created, its content is hashed to produce a unique cryptographic fingerprint. This hash is stored alongside the document and serves as a reference for verifying the integrity of the content. Any attempt to modify the content would result in a mismatch between the original hash and the hash of the altered content, immediately signaling tampering. Additionally, the document may be digitally signed using the creator's private key, ensuring that the content is not only unchangeable but also verifiable as originating from the authorized source.

### Immutable Audit Trail

The audit trail of a smart document is equally immutable. The audit trail records every interaction with the document, including access, modifications, approvals, signatures, and other events. Each event in the audit trail is cryptographically secured and timestamped, ensuring that the sequence of events is preserved and cannot be altered retroactively. For example, when a user accesses the document, the system generates a cryptographic record of the access event, including the user's identity, the time of access, and the nature of the interaction. These records are stored in a manner that prevents deletion or modification, ensuring the audit trail remains a reliable source of truth. The audit trail is also linked to the document's content, creating a unified record of both the document and its history.

### Immutable Connection to a Permanent Global Marker

Both the immutable content and the immutable audit trail are connected to an immutable global marker, which serves as the unique and unchanging identifier for the document. The global marker can be implemented as a universally unique identifier (UUID) or a cryptographic address, such as a hash-based identifier. This marker is permanent and does not change throughout the lifecycle of the document, regardless of how or where the document is accessed. The global marker ensures that the document can always be referenced and retrieved in its original form, providing a single source of truth.

The connection between the content, audit trail, and global marker is established through cryptographic linking. The global marker is embedded in the document's metadata, and the metadata itself is cryptographically secured to prevent tampering. The audit trail is also linked to the global marker, ensuring that every recorded event is associated with the correct document. This triad—immutable content, immutable audit trail, and an immutable association between the global marker and the content and audit trail—creates a robust framework that may impact document management and control.

The immutability of the content, the audit trail, the global marker and of the link between the marker and the data (i.e., the content, the audit trail, and any other metadata) and the global marker, can have one or more of a variety of characteristics:
Unchangeable: Immutable refers to something that cannot be altered, modified, or edited once it has been created or finalized.
Permanent: Immutable signifies a state of permanence, where the object or data remains fixed and consistent over time.
Irreversible: Immutable describes a condition where changes are impossible, and any attempt to alter the object or data is invalid or rejected.
Fixed: Immutable means that the structure, content, or state of an object is locked and cannot be adjusted or updated.
Tamper-Proof: Immutable implies that the object or data is resistant to tampering, ensuring its integrity and authenticity.
Finalized: Immutable refers to an object or data that has reached its final form and cannot be reverted or reshaped.
Unmodifiable: Immutable describes a characteristic where the object or data is impervious to modification, whether intentional or accidental.
Consistent: Immutable ensures that the object or data remains consistent and reliable, unaffected by external influences or changes.
Secure: Immutable denotes a state of security where the object or data is safeguarded against unauthorized alterations or corruption.
Indelible: Immutable refers to something that is permanent and cannot be erased, overwritten, or replaced.

### Benefits of the Immutable Structure

Integrity: The immutability of the content ensures that the document remains unchanged and trustworthy throughout its lifecycle.

Traceability: The immutable audit trail provides a complete and verifiable history of all interactions with the document.

Authenticity: The permanent global marker guarantees that the document can always be uniquely identified and retrieved, eliminating ambiguity.

Compliance: This structure simplifies regulatory compliance by providing a reliable and tamper-proof record of the document and its history.

Interoperability: The global marker enables seamless integration with external systems, ensuring that the document can be referenced and verified across different platforms.

In summary, a smart document achieves immutability of its content and audit trail while ensuring both are immutably connected to a permanent global marker. This design provides a significant solution for document management, offering integrity, authenticity, and traceability.

While in some examples of smart documents the content, the audit trail, and the link to the global marker are all immutable, in other examples one of or two of these three items may be immutable. In some examples, the entirety of the content and the audit trail are immutable, and in others only a portion of the content and/or the audit trail are immutable. Furthermore, a smart document may have content and an audit trail that are immutable while having other metadata that is changeable (e.g., comments, access rights, etc.)

In addition to the foundational features of immutability, smart documents possess embedded intelligence that enables them to actively interact with their environment, respond to requests, and perform actions autonomously. This intelligence transforms the document from a static repository of information into a dynamic, interactive entity capable of understanding and adapting to its context. Embedded intelligence in smart documents is achieved through the integration of executable code, metadata, and machine-readable content, all of which work together to create a responsive and self-aware system.

### Features of Embedded Intelligence

Self-Determination and Responsiveness: Smart documents are equipped with the ability to process requests and respond dynamically. For example, when a user or system queries a document, the embedded intelligence allows the document to access its metadata, audit trail, and content to determine the appropriate response. This responsiveness is not limited to simple data retrieval; the document can also perform complex operations, such as verifying its authenticity, providing access logs, or extracting specific information from its content.

Contextual Awareness: Smart documents can understand and adapt to their context. This includes recognizing the identity of the user accessing the document, the device being used, the location of the access, and the stage of the document's lifecycle. For instance, a contract document may display different user interfaces depending on whether it is being accessed by the creator, a signatory, or a reviewer. Similarly, the document can adapt its behavior based on whether it is being accessed on a mobile device, desktop, or tablet.

Negotiation of Communication Protocols: Smart documents are capable of negotiating the manner in which they communicate with external systems. They can respond to requests using various protocols, such as RESTful APIs, gRPC, or even machine-specific languages like MCP (Machine Communication Protocol). This flexibility ensures that the document can seamlessly integrate with diverse systems and applications, making it highly interoperable.

Dynamic User Experience: The embedded intelligence enables smart documents to create personalized user experiences. For example, the document can present different panels, workflows, or visualizations depending on the user's role, the document's lifecycle stage, or the specific task being performed. This dynamic adaptability enhances usability and ensures that the document serves the needs of each stakeholder effectively.

Machine Learning and Predictive Capabilities: Smart documents can leverage machine learning algorithms to analyze their audit trail, content, and metadata to predict user needs or suggest actions. For instance, a smart document could identify patterns in user interactions and recommend next steps, such as suggesting additional documents that may be relevant to the current task or flagging anomalies in the audit trail for review.

### How Intelligence is Embedded

The intelligence of smart documents is embedded through the integration of one or more components:
Executable Code: At the core of a smart document's intelligence is its embedded executable code. This code acts as the “brain” of the document, enabling it to process requests, perform actions, and interact with external systems. The code is designed to be lightweight and modular, allowing it to execute specific tasks efficiently without compromising the document's performance.
Metadata: Metadata provides the document with contextual information about itself, such as its creation date, owner, version history, and access permissions. This metadata is stored in a machine-readable format and is cryptographically secured to ensure its integrity. The document's intelligence uses this metadata to make decisions and respond to queries.
Machine-Readable Content: Unlike traditional documents, which are primarily human-readable, smart documents store their content in a machine-readable format. This allows the embedded intelligence to analyze the content, extract specific information, and perform operations based on the content's structure and meaning.
APIs for Interaction: Smart documents expose APIs A (Application Programming Interfaces) that allow external systems to interact with them. These APIs enable the document to receive requests, process them, and return responses in a structured format, such as JSON or XML. The APIs also facilitate integration with other applications and systems, making the document highly interoperable.
Cryptographic Infrastructure: The intelligence of smart documents is underpinned by cryptographic infrastructure, which ensures the security and authenticity of the document's interactions. For example, digital signatures and hash-based identifiers are used to verify the integrity of the document and its audit trail, while encryption protects sensitive data.
Machine Learning Models: Machine learning models can be embedded within the document or accessed through external systems to enhance its intelligence. These models enable the document to analyze patterns, predict outcomes, and adapt its behavior based on historical data and real-time inputs.

### Examples of Embedded Intelligence in Action

Audit Trail Analysis: A smart document can analyze its audit trail to identify unusual patterns, such as repeated failed access attempts, and alert the owner to potential security risks.

Dynamic Rendering: When accessed on a mobile device, a smart document can automatically adjust its layout to optimize readability and usability, while providing additional features like touch-based navigation.

Workflow Management: A smart document associated with a workflow can track its progress and notify stakeholders of pending actions, such as signatures or approvals.

Content Extraction: A smart document can respond to a query by extracting specific information from its content, such as the total amount in an invoice or the number of items listed in a receipt.

Protocol Negotiation: A smart document can negotiate the format of its responses based on the preferences of the requesting system, such as providing data in JSON for web applications or XML for enterprise systems.

In summary, the embedded intelligence of smart documents is achieved through the integration of executable code, metadata, machine-readable content, APIs, cryptographic infrastructure, and machine learning models. This intelligence enables the document to interact dynamically with its environment, adapt to its context, and provide personalized experiences, making it a significant improvement in document management.

The combination of immutability and embedded intelligence in smart documents creates a paradigm for document management, offering unparalleled integrity, authenticity, traceability, and adaptability. Together, these features address longstanding challenges in document security, compliance, and usability, while enabling dynamic interactions and personalized experiences.

### The Synergy of Immutability and Embedded Intelligence

The combination of immutability and embedded intelligence creates a powerful synergy that impacts document management. Immutability provides the foundation of trust, ensuring that the document's content and history are secure, authentic, and tamper-proof. Embedded intelligence builds on this foundation, enabling the document to interact dynamically with its environment, adapt to its context, and provide personalized experiences.

Enhanced Integrity and Authenticity: Immutability ensures that the document's content and audit trail remain unchanged, while embedded intelligence enables the document to verify its authenticity and respond to queries about its provenance. Together, these features create a system where trust is inherent and verifiable.

Dynamic Traceability: The immutable audit trail provides a complete history of interactions with the document, while embedded intelligence allows the document to analyze and interpret this history. This dynamic traceability enables stakeholders to understand not only what happened to the document but also why and how.

Personalized Compliance: Immutability simplifies regulatory compliance by providing a reliable and tamper-proof record of the document and its history. Embedded intelligence enhances this by adapting the document's behavior to meet specific compliance requirements, such as displaying relevant panels or workflows based on the user's role or jurisdiction.

Interoperability and Adaptability: The permanent global marker ensures seamless integration with external systems, while embedded intelligence enables the document to negotiate communication protocols and adapt its responses to different platforms. This combination ensures that the document can function effectively in diverse environments.

Predictive Security and Usability: Immutability protects the document from tampering, while embedded intelligence leverages machine learning to predict potential security risks and suggest preventive actions. This proactive approach enhances both security and usability, ensuring that the document serves the needs of its stakeholders effectively.

### Real-World Applications

The synergy of immutability and embedded intelligence has significant implications across industries:
Legal and Compliance: Smart contracts can ensure the integrity of agreements while dynamically adapting to regulatory changes.
Finance: Immutable audit trails and intelligent analysis can enhance fraud detection and streamline reporting.
Healthcare: Patient records can remain secure and authentic while providing personalized access to authorized stakeholders.
Supply Chain: Immutable tracking and intelligent analysis can optimize logistics and ensure product authenticity.

In summary, the combination of immutability and embedded intelligence in smart documents creates a revolutionary framework for document management. By ensuring integrity, authenticity, and traceability while enabling dynamic interactions and personalized experiences, this synergy addresses longstanding challenges and unlocks new possibilities for innovation and efficiency.

### ALTERNATIVE TERMINOLOGY

The term “smart document” or “smart electronic document” can also be referred to as a self-determinative document, a self-tracking document, a self-assimilating document, a document with executable code, a document with embedded code, and/or in a variety of other ways depending on the context and on the features of the smart document. In any example, a smart electronic document includes three elements, at minimum-data (e.g., content, audit trail, other metadata, etc.), executable code (e.g., an API), and a globally unique marker.

A self-administering document can be a technical solution to the persistent problem of ensuring data integrity, security, and operational efficiency in digital document systems, which are often susceptible to unauthorized modifications, fragmented audit trails, and inefficient management. This advanced document structure incorporates immutable content and an immutable audit trail, both immutably connected to an immutable global identifier, creating a tamper-proof and trustworthy framework that ensures the document's content, history, and identity remain intact.

The machine-readable design of the self-administering document enables seamless integration with computational systems, allowing automated querying, verification, and processing of its data and interactions. Furthermore, the self-governing document embeds intelligence in the form of executable code, which allows it to be responsive and interactive. This embedded code can empower the document to autonomously enforce access permissions, execute workflows, and dynamically respond to user or system queries, transforming it from a static file into a dynamic, self-regulating entity. By combining immutability, machine-readability, and embedded intelligence, the self-governing document provides a robust solution to the challenges of document security, traceability, and operational inefficiencies in modern digital ecosystems.

A self-administering document can address the problems of data security, inefficient use of device hardware, and inefficient use of network systems associated with traditional PDFs by leveraging its immutable structure, embedded intelligence, and machine-readable design. In terms of data security, the document's cryptographic commitments can ensure that its content, audit trail, and global identifier remain tamper-proof and trustworthy, eliminating vulnerabilities inherent in PDFs, which often rely on external systems for encryption and access control.

The embedded intelligence within the self-administering document can autonomously enforce granular access permissions, dynamically adapting to user roles and security protocols, reducing the risk of unauthorized access and ensuring compliance with stringent security requirements. Regarding device hardware, traditional PDFs require significant computational resources for rendering, extracting data, and managing versions, often leading to inefficiencies and hardware strain. A self-administering document, with its machine-readable format and embedded intelligence, can eliminate or reduce the need for complex text extraction algorithms and redundant processing, optimizing the use of device hardware and enabling faster, more efficient operations.

Similarly, network systems that handle PDFs often experience bandwidth inefficiencies due to the need to transmit large, static files and duplicate versions. A self-administering document can address this by maintaining a single source of truth that is universally accessible via its global identifier, reducing the need to transmit entire files and instead enabling lightweight, API-driven interactions. This approach can minimize network bandwidth usage, streamlines workflows, and ensures that documents are securely and efficiently managed across devices and systems, making them ideal for modern digital ecosystems.

A self-administering document may address the problems of data security, inefficient use of device hardware, and inefficient use of network systems associated with traditional PDFs by leveraging its immutable structure, embedded intelligence, and machine-readable design. In terms of data security, the document's cryptographic commitments can ensure that its content, audit trail, and global identifier remain tamper-proof and trustworthy, eliminating vulnerabilities inherent in PDFs, which often rely on external systems for encryption and access control. The embedded intelligence within the self-administering document can autonomously enforce granular access permissions, dynamically adapting to user roles and security protocols, reducing the risk of unauthorized access and ensuring compliance with stringent security requirements.

Regarding device hardware, traditional PDFs require significant computational resources for rendering, extracting data, and managing versions, often leading to inefficiencies and hardware strain. A self-administering document, with its machine-readable format and embedded intelligence, can eliminate the need for complex text extraction algorithms and redundant processing, optimizing the use of device hardware and enabling faster, more efficient operations. Similarly, network systems that handle PDFs often experience bandwidth inefficiencies due to the need to transmit large, static files and duplicate versions. A self-administering document can address this by maintaining a single source of truth that is universally accessible via its global identifier, reducing the need to transmit entire files and instead enabling lightweight, API-driven interactions. This approach may minimize network bandwidth usage, streamlines workflows, and ensures that documents are securely and efficiently managed across devices and systems, making them ideal for modern digital ecosystems.

The disclosed systems and methods provide a technical solution to the technical problem of securely managing access to electronic documents in environments where multiple users require varying levels of access to sensitive information. Certain aspects address this problem by leveraging computer hardware and network infrastructure to implement self-administering documents that autonomously enforce fractional access rights. For example, some aspects rely on computer hardware, including physical processors and memory, to execute instructions that enable the document to track access rights, evaluate access requests, and provide selective access to authorized data subsets. By embedding intelligence within the document itself, the invention eliminates the need for centralized access control systems, reducing network congestion and reliance on external servers. This distributed approach enhances scalability and efficiency, as the document can independently process access requests without requiring constant communication with a central authority.

Additionally, the methods and systems described herein use a network infrastructure to facilitate the exchange of information between the self-administering document and external systems or users. For example, when a user submits an access request, the document interacts with the network to authenticate the user and retrieve relevant access permissions. In some aspects, the use of self-administering documents reduces network traffic and enables servers to be more efficient and use fewer computing resources.

In conclusion, the disclosed systems and methods provide an efficient and effective solution to one or more of the challenges of managing access to electronic documents in multi-user environments. By leveraging self-administering documents equipped with embedded intelligence, the invention enables fractional access control, ensuring that users can access only the information they are authorized to view. Through the integration of computer hardware, such as physical processors and memory, and network infrastructure, the system autonomously tracks access rights, evaluates requests, and provides selective access to data subsets. This approach eliminates the need for centralized access control systems, enhances scalability, and reduces system overhead. Furthermore, the invention supports a wide range of use cases, including legal compliance, subscription-based content delivery, and security clearance management, while maintaining data integrity and confidentiality. By addressing these technical challenges, the invention offers a secure, efficient, and flexible framework for managing electronic documents in diverse organizational and regulatory contexts.

Clause 1. A method comprising: tracking, by a self-administering document, fractional access rights to the self-administering document; receiving, at the self-administering document, a request to access the self-administering document; determining, based on the fractional access rights, that an entity making the request is allowed to access a subset of data associated with the document; and providing, in response to the determination and via the self-administering document, access to the subset.

Clause 2. The method of clause 1, wherein determining that the entity is allowed to access a subset of data associated with the self-administering document comprises determining that portions of data not contained within the subset are behind a paywall.

Clause 3. The method of clauses 1-2, wherein determining that the entity is allowed to access a subset of data associated with the self-administering document comprises determining that the portions of the self-administering document are behind a tier of the paywall for which the entity is not subscribed.

Clause 4. The method of clauses 1-3, wherein determining that the entity is allowed to access a subset of data associated with the self-administering document comprises determining that a different subset of data comprises personally identifiable information.

Clause 5. The method of clauses 1-4, wherein providing access to the subset comprises redacting a different subset of data associated with the document.

Clause 6. The method of clauses 1-5, wherein redacting the different subset is based on the self-administering document determining that the entity does not have clearance with respect to the different subset of data.

Clause 7. The method of clauses 1-6, wherein providing access to the subset comprises determining that the entity is under a non-disclosure agreement that allows it to access the subset.

Clause 8. A system comprising: one or more physical processors; and physical memory comprising computer-executable instructions that, when executed by the one or more physical processors, cause at least one of the one or more physical processors to: track, by a self-administering document, fractional access rights to the self-administering document; receive, at the self-administering document, a request to access the self-administering document; determine, based on the fractional access rights, that an entity making the request is allowed to access a subset of data associated with the document; and provide, in response to the determination and via the self-administering document, access to the subset.

Clause 9. The system of clause 8, wherein the computer-executable instructions cause the one or more physical processors to determine that the entity is allowed to access a subset of data associated with the self-administering document by determining that portions of data not contained within the subset are behind a paywall.

Clause 10. The system of clauses 8-9, wherein the computer-executable instructions cause the one or more physical processors to determine that the entity is allowed to access a subset of data associated with the self-administering document by determining that the portions of the self-administering document are behind a tier of the paywall for which the entity is not subscribed.

Clause 11. The system of clauses 8-10, wherein the computer-executable instructions causing the one or more physical processors to determine that the entity is allowed to access a subset of data associated with the self-administering document comprise determining that a different subset of data comprises personally identifiable information.

Clause 12. The system of clauses 8-11, wherein the computer-executable instructions causing the one or more physical processors to provide access to the subset comprises redacting a different subset of data associated with the document.

Clause 13. The system of clauses 8-12, wherein the computer-executable instructions causing the one or more physical processors to redact the different subset is based on the self-administering document determining that the entity does not have clearance with respect to the different subset of data.

Clause 14. The system of clauses 8-13, wherein the computer-executable instructions causing the one or more physical processors to access to the subset comprises determining that the entity is under a non-disclosure agreement that allows it to access the subset.

Clause 15. A non-transitory computer-readable medium comprising computer-executable instructions that, when executed by one or more physical processors of a computing device, cause the computing device to: track, by a self-administering document, fractional access rights to the self-administering document; receive, at the self-administering document, a request to access the self-administering document; determine, based on the fractional access rights, that an entity making the request is allowed to access a subset of data associated with the document; and provide, in response to the determination and via the self-administering document, access to the subset.

Clause 16. The non-transitory computer-readable medium of clause 15, wherein the computer-executable instructions cause the one or more physical processors to determine that the entity is allowed to access a subset of data associated with the self-administering document by determining that portions of data not contained within the subset are behind a paywall.

Clause 17. The non-transitory computer-readable medium of clauses 15-16, wherein the computer-executable instructions cause the one or more physical processors to determine that the entity is allowed to access a subset of data associated with the self-administering document by determining that the portions of the self-administering document are behind a tier of the paywall for which the entity is not subscribed.

Clause 18. The non-transitory computer-readable medium of clauses 15-17, wherein the computer-executable instructions causing the one or more physical processors to determine that the entity is allowed to access a subset of data associated with the self-administering document comprises determining that a different subset of data comprises personally identifiable information.

Clause 19. The non-transitory computer-readable medium of clauses 15-18, wherein the computer-executable instructions causing the one or more physical processors to provide access to the subset comprises redacting a different subset of data associated with the document.

Clause 20. The non-transitory computer-readable medium of clauses 15-19, wherein the computer-executable instructions causing the one or more physical processors to redact the different subset is based on the self-administering document determining that the entity does not have clearance with respect to the different subset of data.

The features and clauses discussed herein may provide one or more of the advantages and/or solutions described, such as enhancing security, improving operational efficiency, or enabling dynamic access control. Additionally, these features and clauses may offer further or alternative benefits or address further or alternative challenges beyond those explicitly mentioned. The disclosed features and clauses are not limited to the specific advantages or solutions described and may be implemented in various ways to achieve additional or alternative benefits and/or solutions.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
tracking, by a self-administering document, fractional access rights to the self-administering document;
receiving, at the self-administering document, a request to access the self-administering document;
determining, based on the fractional access rights, that an entity making the request is allowed to access a subset of data associated with the document; and
providing, in response to the determination and via the self-administering document, access to the subset.

2. The method of claim 1, wherein determining that the entity is allowed to access a subset of data associated with the self-administering document comprises determining that portions of data not contained within the subset are behind a paywall.

3. The method of claim 2, wherein determining that the entity is allowed to access a subset of data associated with the self-administering document comprises determining that the portions of the self-administering document are behind a tier of the paywall for which the entity is not subscribed.

4. The method of claim 1, wherein determining that the entity is allowed to access a subset of data associated with the self-administering document comprises determining that a different subset of data comprises personally identifiable information.

5. The method of claim 1, wherein providing access to the subset comprises redacting a different subset of data associated with the document.

6. The method of claim 5, wherein redacting the different subset is based on the self-administering document determining that the entity does not have clearance with respect to the different subset of data.

7. The method of claim 1, wherein providing access to the subset comprises determining that the entity is under a non-disclosure agreement that allows it to access the subset.

8. The method of claim 1, wherein the self-administering document is embedded with intelligence that performs the tracking, determining, receiving, and providing steps and that enables the self-administering document to autonomously manage interactions with and access permissions of the self-administering document.

9. The method of claim 1, wherein providing access control to the subset comprises determining that the entity satisfies at least one access control criterion associated with the subset.

10. The method of claim 1, wherein the self-administering document is uniquely addressable and possesses a permanent and immutable identifier that distinguishes it from all other documents.

11. The method of claim 1, wherein content of the self-administering document is immutable in that the content cannot be altered once finalized.

12. The method of claim 1, further comprising recording, by the self-administering document, each interaction with the document in an audit trail that is cryptographically secured and timestamped such that the audit trail is immutable and cannot be altered retroactively.

13. The method of claim 1, wherein providing access to the subset provides access to only content that the entity is authorized to access in a manner that does not indicate that additional content exists.

14. The method of claim 1, wherein the self-administering document is configured to interact with an artificial intelligence agent using a specialized protocol.

15. The method of claim 1, wherein the self-administering document is configured to maintain an audit trail for interactions between artificial intelligence agents and the self-administering document by recording which agents accessed which portions of the self-administering document and for what purpose.

16. The method of claim 1, wherein the self-administering document enables artificial intelligence analysis of engagement with the self-administering document.

17. A system comprising:
one or more physical processors; and
physical memory comprising computer-executable instructions that, when executed by the one or more physical processors, cause at least one of the one or more physical processors to:
track, by a self-administering document, fractional access rights to the self-administering document;
receive, at the self-administering document, a request to access the self-administering document;
determine, based on the fractional access rights, that an entity making the request is allowed to access a subset of data associated with the document; and
provide, in response to the determination and via the self-administering document, access to the subset.

18. The system of claim 17, wherein the computer-executable instructions cause the one or more physical processors to determine that the entity is allowed to access a subset of data associated with the self-administering document by determining that portions of data not contained within the subset are behind a paywall.

19. The system of claim 18, wherein the computer-executable instructions cause the one or more physical processors to determine that the entity is allowed to access a subset of data associated with the self-administering document by determining that the portions of the self-administering document are behind a tier of the paywall for which the entity is not subscribed.

20. The system of claim 17, wherein the computer-executable instructions causing the one or more physical processors to determine that the entity is allowed to access a subset of data associated with the self-administering document comprises determining that a different subset of data comprises personally identifiable information.

21. The system of claim 17, wherein the computer-executable instructions causing the one or more physical processors to provide access to the subset comprises redacting a different subset of data associated with the document.

22. The system of claim 21, wherein the computer-executable instructions causing the one or more physical processors to redact the different subset is based on the self-administering document determining that the entity does not have clearance with respect to the different subset of data.

23. The system of claim 17, wherein the computer-executable instructions causing the one or more physical processors to access the subset comprises determining that the entity is under a non-disclosure agreement that allows it to access the subset.

24. A non-transitory computer-readable medium comprising computer-executable instructions that, when executed by one or more physical processors of a computing device, cause the computing device to:
track, by a self-administering document, fractional access rights to the self-administering document;
receive, at the self-administering document, a request to access the self-administering document;
determine, based on the fractional access rights, that an entity making the request is allowed to access a subset of data associated with the document; and
provide, in response to the determination and via the self-administering document, access to the subset.

25. The non-transitory computer-readable medium of claim 24, wherein the computer-executable instructions cause the one or more physical processors to determine that the entity is allowed to access a subset of data associated with the self-administering document by determining that portions of data not contained within the subset are behind a paywall.

26. The non-transitory computer-readable medium of claim 25, wherein the computer-executable instructions cause the one or more physical processors to determine that the entity is allowed to access a subset of data associated with the self-administering document by determining that the portions of the self-administering document are behind a tier of the paywall for which the entity is not subscribed.

27. The non-transitory computer-readable medium of claim 24, wherein the computer-executable instructions causing the one or more physical processors to determine that the entity is allowed to access a subset of data associated with the self-administering document comprises determining that a different subset of data comprises personally identifiable information.

28. The non-transitory computer-readable medium of claim 24, wherein the computer-executable instructions causing the one or more physical processors to provide access to the subset comprises redacting a different subset of data associated with the document.

29. The non-transitory computer-readable medium of claim 28, wherein the computer-executable instructions cause the one or more physical processors to redact the different subset is based on the self-administering document determining that the entity does not have clearance with respect to the different subset of data.
